(19) United States
(12) Patent Application Publication
(10) Pub. No.: US 2025/0194474 A1
(43) Pub. Date: Jun. 19, 2025

(54) PLANT ILLUMINATION DEVICE ARRANGED TO BE POSITIONED ABOVE A PLANT TRAY SUCH AS TO ILLUMINATE PLANTS IN THE PLANT TRAY

(71) Applicant: COLRUYT GROUP, Halle (BE)

(72) Inventors: Kris BAERT, Halle (BE); Wouter DEVARREWAERE, Halle (BE); Jan AUDENAERT, Leuven (BE); Frederic LELOUP, Leuven (BE)

(21) Appl. No.: 18/847,343

(22) PCT Filed: Mar. 2, 2023
(86) PCT No.: PCT/EP2023/055284

§ 371 Date: Sep. 16, 2024

(30) Foreign Application Priority Data
Mar. 16, 2022 (BE) BE2022/5184

(51) Int. Cl. A01G 9/24; F21S 4/28; F21V 7/00; F21V 7/04; F21V 7/06; F21Y 105/16; F21Y 113/10; F21Y 115/10

(52) U.S. Cl. CPC A01G 9/249; F21S 4/28; F21V 7/0008; F21V 7/048; F21V 7/06; F21Y 2105/16; F21Y 2113/10; F21Y 2115/10

(57) ABSTRACT

A plant illumination device positioned above a plant tray to illuminate plants in the plant tray is disclosed. The device comprises a reflector and a light source, wherein the light source is arranged to emit light directed towards the reflector and the light is reflected by the reflector towards the plant tray. The reflector has a shape in a cross-sectional plane perpendicular to a length direction wherein the shape comprises a central portion and two peripheral portions adjacent to the central portion and the shape is symmetrical with respect to an axis of symmetry extending through the central portion along a height direction perpendicular to the length direction, The central portion comprises a protrusion at the axis of symmetry that protrudes downward along the height direction towards the light source. The peripheral portions of the reflector reflect the light received from the central portion towards the plant tray.

### CROSS-REFERENCE TO RELATED APPLICATION(S)

This present application is a national stage application of International Patent Application No. PCT/EP2021/055284, filed Mar. 2, 2023, which claims priority to Belgium Patent Application No. 2022/5184, filed Mar. 16, 2022, the disclosures of which are hereby incorporated by reference in their entireties.

### TECHNICAL FIELD

The present disclosure relates to a plant illumination device arranged to be positioned above a plant tray such as to illuminate plants in the plant tray, as well as to a plant growing system comprising such a plant illumination device. The disclosure also relates to a method for creating such a plant growing system.

### BACKGROUND

Plant illumination devices have been developed in the prior art for illuminating plant trays. A plant tray comprises a planting surface for receiving plants. For example, a plant illumination device for illuminating a plant tray is known from patent publication EP3772897. The planting surface is a surface comprising a mutually perpendicular length and width direction, i.e. the planting surface is perpendicular to a height direction. The plant illumination device comprises a light source elongated in the length direction. In FIG. 4 of patent publication EP3772897 four parallel light sources are provided each being elongated along the length direction. In the known devices, the light source directly illuminates the plants in the plant tray. This had the disadvantage that the irradiance of the light reaching plants in the plant tray depends on the position of the plants in the plant tray, i.e. the plants directly below the light source would receive light with a higher irradiance than the plants that are at a different position in the width direction. It has however been found that the irradiance of the light affects plant growth, and thus the traditional plant illuminating devices have the problem that plants in the plant tray are not lit with a uniform irradiance which results in non-uniform plant growth. A known solution in the state of the art is to increase the number of parallel elongated light sources per unit length along the width direction such as to increase irradiance uniformity. This however results in a higher capex and opex.

### SUMMARY

The present disclosure provides a solution to the problem encountered in the state of the art. To that end, the present disclosure provides a plant illumination device arranged to be positioned above a plant tray such as to illuminate plants in the plant tray, according to the first claim. In use, the plant tray comprises a planting surface for receiving plants. The planting surface is a surface comprising a mutually perpendicular length and width direction, i.e. the planting surface is perpendicular to a height direction. Typically, the plant tray is positioned horizontally on a floor or hung horizontally from a ceiling, and the height direction is then the direction along the gravitational acceleration vector. Sometimes however the plant tray is attached to a wall, the height direction then being a direction perpendicular to the gravitational acceleration vector. The terms “upper” or “above” in the present disclosure corresponds to a position or element that is more remote along the height direction from the plant tray with respect to the position or element denominated by the term “lower” or “below”. The terms “upward” and “downward” signify a direction respectively “from a lower position to an upper position” and “from an upper position to a lower position”. The plant illumination device comprises a light source elongated in a length direction. In the present patent application the elongation direction of the light source determines the length direction of the illumination device. The plant illumination device furthermore comprises a reflector in addition to the above mentioned light source. The reflector is positioned above the light source. The light source is arranged to emit light which is at least directed towards the reflector and which is preferably solely directed towards the reflector, i.e. wherein the light source is not directly irradiating the plant tray. The light source and the reflector are positioned such that the light emitted by the light source is reflected by the reflector towards the plant tray. In other words, in use, the light source is positioned between the reflector and the plant tray. The reflector and the light source are both elongated along the length direction and the reflector has a shape in a cross-sectional plane perpendicular to the length direction wherein said shape comprises a central portion and two peripheral portions adjacent to the central portion. The shape is symmetrical with respect to an axis of symmetry extending through the central portion along the height direction. Given that the reflector is elongated in the length direction, the reflector is symmetric along a plane of symmetry comprising the axis of symmetry and extending along the height and length direction. The central portion comprises a protrusion at the axis of symmetry wherein the protrusion protrudes downward along the height direction towards the light source. Preferably the light source is provided adjacent to the protrusion along the width direction, i.e. either directly below the protrusion or close by to it. The central portion of the reflector is arranged to receive light from the light source and to reflect the received light towards the peripheral portions of the reflector. The peripheral portions of the reflector are arranged to reflect the light received from the central portion towards the plant tray. This reflector has the advantage that a more uniform light irradiance is obtained over the planting surface (i.e. the irradiance uniformity can be increased). Indeed, light is no longer concentrated at a position directly below the light source as is the case in the prior art as it is spread out over a greater width by means of the reflector. This disclosure has the additional advantage that the power provided to the light source can be lowered. Indeed, in the prior art, the light source power was overpowered such as to deliver the minimal required amount of light to the plants at the peripheral edges of the plant tray. This disclosure has the additional advantage that less light sources have to be provided per unit length along the width direction. The distance between light sources is for example between 140 cm and 240 cm. This decrease in the amount of illumination devices entails a decrease in the amount of required water cooling, a decrease in the installation cost, a decrease in the amount of required materials to build the plant growing system etc.

According to an embodiment of the present disclosure, the peripheral portions are arranged to reflect light in a partly or perfectly diffuse manner, i.e. as opposed to in a perfectly specular manner. This has the advantage of increasing the uniformity of the light irradiance on the planting surface (i.e. it increases irradiance uniformity), and has the advantage that plants are irradiated with diffuse light which promotes plant growth for example due to the alleviation of shadowing effects between plants or between plant parts. Preferred implementation details regarding the amount of diffusive reflectance of the peripheral portions are given further below.

According to an embodiment of the present disclosure, the protrusion divides the reflector into two adjacent concave elements.

According to an embodiment of the present disclosure, the central portion on one side of the axis of symmetry comprises an approximatively parabolic line which terminates on the axis of symmetry such as to form the protrusion of the central portion of the reflector. For completeness, due to symmetry, the central portion on the other side of the axis of symmetry also comprises an approximatively parabolic line which terminates on the axis of symmetry such as to form the protrusion of the central portion of the reflector. This creates a parabolic reflector which has the advantage to increase the uniformity of the light irradiance over the planting surface (i.e. it increased irradiance uniformity). According to an embodiment of the present disclosure, the approximatively parabolic line is a piecewise linear approximation of a parabola. This embodiment facilitates the production of the reflector. Preferably, the piecewise linear approximation comprises at least three linear sections. Alternatively, the approximatively parabolic line is a parabolic line, i.e. forms a smooth parabolic curve.

According to an embodiment of the present disclosure, the reflector comprises a width direction perpendicular to the height direction and the length direction, and the central portion of the reflector is the portion of the reflector that is shaped such that with increasing distance from the apex of the protrusion along the width direction, the height along the height direction increases. According to an embodiment of the present disclosure, the reflector comprises a width direction perpendicular to the height direction and the length direction, and the peripheral portions of the reflector are the portions of the reflector that are substantially flat or the peripheral portions of the reflector are the portions of the reflector that are shaped such that with increasing distance from the apex of the protrusion along the width direction, the height along the height direction decreases.

According to an embodiment of the present disclosure, the reflector comprises separate parts, i.e. a central part on which the central portion is provided and a ceiling part on which the two peripheral portions are provided. Preferably, the central part and the peripheral parts are made of different materials.

It has been found that, depending on the plant type, certain wavelengths of light are optimally absorbed by the plants, whilst other wavelengths are merely reflected by the plants. It has furthermore been found that certain combinations of wavelengths of light, i.e. certain spectral mixtures of light, the specific mixture depending on the type of plant, enable to optimally grow the plants. It has thus been found by the present inventors that the light source of the plant illumination device can be adapted such as to optimally grow a particular plant type. One implementation method comprises implementing the light source as a single elongated light strip comprising lighting elements such as LED's of which at least two are arranged to emit light of a different wavelength range, e.g. one LED that is arranged to emit predominantly blue light and another LED that is arranged to emit predominantly red light. In order to optimally grow a particular plant type, one merely has to provide an elongated light strip comprising the correct amount of lighting elements of every type, i.e. arranged to emit a particular wavelength range. It has however also been found by the present inventors that providing a single elongated light strip comprising different types of lighting elements has the disadvantage that providing such a single strip drastically complicates the design of the light strip PCB (“Printed Circuit Board”). After all, due to the exceptionally large surface that can be illuminated with one plant illumination device, and the large amount of power desired from the light source, a large number of lighting elements such as LED diodes have to be placed on a small PCB strip. Therefore, according to a second preferred implementation method, the light source comprises on each side of the axis of symmetry a plurality of parallel elongated light strips, i.e. light strips elongated along the length direction. The plurality of elongated light strips are placed adjacent to each other along a width direction perpendicular to the height direction and the length direction. At least two of the plurality of elongated light strips on each side of the axis of symmetry are arranged to emit light at a different range of wavelengths, i.e. having a different spectral distribution for example centered around a different predominant wavelength. Each light strip thus comprises the same lighting elements e.g. the same types of LEDs, all arranged to emit light at the same range of wavelengths. This drastically facilitates the design of the PCBs to drive the light strips. Preferably, the light source is provided below the protrusion and adjacent to the protrusion along the width direction, i.e. either directly below the protrusion or close by to it. In case the light source comprises a single light strip, said light strip is preferably positioned directly below the protrusion. In case the light source comprises multiple light strips, the light strips are preferably positioned below the protrusion and close to the protrusion along the width direction. The multiple light strips are for example concentrated around the protrusion on a plane provided below the protrusion. However, the closer the lighting elements are positioned to the axis of symmetry, the more sensitive the light distribution becomes to the accurate placement of the lighting elements with respect to the axis of symmetry. Therefore, the light strips are preferably separated from the axis of symmetry along the width direction by a distance of between one to ten centimeters, for example between one and five centimeters. Preferably, the multiple light strips are provided directly below the central portion and not directly below the peripheral portions.

According to an embodiment of the present disclosure, the light source is arranged to emit PAR light. According to an embodiment of the present disclosure, at least one of the plurality of elongated light strips on each side of the axis of symmetry is arranged to emit predominantly blue light, and wherein at least one of the plurality of elongated light strips on each side of the axis of symmetry is arranged to emit predominantly red light.

According to an embodiment of the present disclosure, the elongated light strips are strips of LEDs. Preferably, the LEDs are cooled by means of a cooling system as described in patent publication EP3772897 which is incorporated herein by reference.

It has been found by the present inventors that it is not only important to have a substantially uniform irradiance over the planting surface (i.e. a high irradiance uniformity), but also to have a substantially uniform spectral mixture of light on the planting surface (i.e. a high spectral uniformity) such that every plant receives the same stimulus to grow, i.e. it is beneficial if every plant in the plant tray receives light having the same spectral mixture. If a single elongated light strip comprising different types of lighting elements as described above would be positioned on the axis of symmetry, then the light reflected by the reflector would have a substantially uniform spectral mixture in the planting surface below the reflector, i.e. independent of the position along the width direction. However, according to a preferred embodiment of the present disclosure as described above, different light strips are separated from each other along the width direction. This results in the fact that the light coming from the different light strips are differently reflected by the reflector towards the plant tray, i.e. as a function of the light strip's position along the width direction the light rays of said light strip would be reflected by the central portion of the reflector towards a different position on the peripheral portion of the reflector and thus to a different position along the width direction on the plant tray. This results in a decreased irradiance uniformity and decreased spectral uniformity of the light on the planting surface. In order to resolve this problem, both the central and the peripheral portions of the reflector are arranged to diffusively reflect the light from the light source, i.e. they are both not perfectly specular reflective. Furthermore, the diffuse reflectance, i.e. the degree of diffusive reflection, of the peripheral portions is chosen to be higher than the diffuse reflectance of the central portion. Preferably the central portion is arranged to reflect light in a partly diffusive manner. Preferably the peripheral portions are arranged to reflect light in a substantially perfectly diffusive manner.

The optical properties of a material determine how light behaves when it falls on it. The most important optical properties are light transmission, absorption and reflection. Preferably, the total integrated scatter (i.e. the total reflection) of the central portion of the reflector and/or of the peripheral portion if the reflector, is more than 90%, more preferably more than 95%. This ensures that losses are minimized. Reflection determines at what angle light is reflected when it falls on a material from a given angle. A perfectly specular reflective material will reflect the light at the same angle with respect to the normal of the surface of the material as the angle of incidence with respect to the normal of the surface of the material (i.e. the light is mirrored around the normal of the surface of the object on which the light fell). A perfectly diffuse reflective material scatters the incident light equally in all directions, regardless of the angle of incidence with respect to the normal of the surface of the material. The degree of scattering can also be somewhere between these two extremes (i.e. between perfectly diffuse and perfectly specular). In this case, after interaction with the reflective material, the light remains somewhat bundled around the reflection direction that would be obtained in a perfectly specular reflection. This phenomenon is illustrated in FIGS. 6a, 6b and 6c, wherein respectively perfectly specular, perfectly diffuse and partly diffuse reflection are shown. The figures show a plane comprising the incoming light ray and the surface normal.

In a first optional implementation, the degree of light scattering in partly diffuse reflection, around the reflection direction that would be obtained in a perfectly specular reflection (which direction is also referred to as the “specular reflection direction”), can be represented by a full width at half maximum of the BRDF (bidirectional reflectance distribution function). The maximum BRDF value is obtained in the specular reflection direction. Preferably, the BRDF model is symmetrical.

Preferably, the full width at half maximum of the three dimensional BRDF is evaluated in a plane comprising the incoming light ray and the surface normal wherein preferably said plane is the plane perpendicular to the length direction of the reflector. Preferably, the material of the central portion of the reflector exhibits an optimal diffusivity that can be represented as having a full width at half maximum which lies in the range of 20° to 120°, preferably in the range of 30° to 90°, more preferably in the range of 40° to 60°. Note that these values are full widths of scatter angles obtained at half of the maximum BRDF value, and that it might be clearer to describe the half width at half maximum which is simply the half of the full width at half maximum in case of symmetry of the partly diffuse reflection around the specular reflection direction (for example when considering a BRDF model which is symmetrical). Thus the half width at half maximum preferably lies in the range of 10° to 60°. Preferably, the material of the peripheral portions of the reflector exhibits a diffusivity that can be represented as having a full width at half maximum which lies above 120°, preferably above 160°. Preferably, the material of the peripheral portions is such that the full width at half maximum does not exist, i.e. the radiant intensity does not drop below the half maximum on any scatter angle in the range of −90° to +90° for a flat surface.

In a second preferred implementation (i.e. instead of or in addition to using the above mentioned full width at half maximum values), the degree of light scattering in partly diffuse reflection, around the reflection direction that would be obtained in a perfectly specular reflection (which direction is also referred to as the “specular reflection direction”), can be represented as a “cos^n” BRDF (bidirectional reflectance distribution function) model, wherein “n” is a variable parameter. Preferably, the BRDF model is symmetrical. Preferably, the three dimensional BRDF model is evaluated in a plane comprising the incoming light ray and the surface normal wherein preferably said plane is the plane perpendicular to the length direction of the reflector. FIG. 7 shows such cos^n functions for n being 0, 1, 10 and 30. The horizontal axis represents the scattering angle, i.e. the deviation from the specular reflection direction. The vertical axis represents the amount of light scattered per steradian. The illustrated curves have been normalized such that the integral of the BRDF model in spherical polar coordinates are equal.

The higher the diffusive reflectance of the surface, the lower the n value of the cos^n function, and the wider the light is scattered when reflected. For a perfect diffuser, n equals 0. The larger n, the more the light remains bundled around the specular reflection direction. The finding in this patent application is that the material of the central portion of the reflector exhibits an optimal diffusivity that can be represented as a cos^n function wherein n is between 10 and 200, preferably between 25 and 50, preferably approximatively 30. This finding can be stated in other words, namely that the diffusive reflectance of the central portion is between cos^10 and cos^200, preferably between cos^25 and cos^50, preferably approximatively cos^30. This allows the reflected radiating light to be sufficiently “directed”, but it is still sufficiently scattered. The more you deviate from this optimal material property, the less good the uniformity of the total irradiation and of its spectral composition on the planting surface will be. Preferably, the central portion is made out of aluminum. Aluminum after all can be easily treated to obtain the above mentioned diffusive reflectance. Similarly, it is preferred that the diffusive reflectance of the peripheral portions is below cos^20, preferably below cos^10, more preferably below cos^5. Preferably, the peripheral portions are made out of or coated with MCPET or I-reflect. These materials enable to obtain the above mentioned diffusive reflectance.

It is a further object of the present disclosure to provide a plant illumination unit wherein the plant illumination unit comprises multiple plant illumination devices as described above. Preferably, the multiple plant illumination devices are placed parallel to each other by placing the elongated light source of each plant illumination device parallel to each other.

It is a further object of the present disclosure to provide a plant growing system comprising a plant tray extending in the length and width directions, and the plant illumination device as described above. Preferably, the plant growing system comprises multiple plant illumination devices, i.e. it comprises the plant illumination unit as described above. The plant illumination device (or where applicable the plant illumination unit) is positioned in the height direction above the plant tray such that the light source is positioned between the reflector and the plant tray. According to an embodiment of the present disclosure, the plant tray is covered in a reflective material, preferably MCPET or I-reflect. This ensures that light is not absorbed by the plant tray and that the plants are also lit from beneath when the plant tray is not yet entirely covered by leaf cover. According to an embodiment of the present disclosure, the plant tray is a hydroponics based plant tray. Preferably, the hydroponics based plant tray is a plant tray wherein the plants are positioned in gutters, for example moveable gutters. Preferably the gutters are covered with the above mentioned reflective material.

It is a further object of the present disclosure to provide a method for providing a plant growing system as described above. The method comprises the steps of:
obtaining boundary conditions comprising a) the distance between the light source and the planting surface of the plant tray, b) the dimensions of the planting surface of the plant tray, and c) the distance between the light source and the protrusion of the reflector, and
determining the shape of the reflector, and the diffusive reflectance of the central portion and the peripheral portions such as to optimize the spectral uniformity and the irradiance uniformity of the light which is reflected by the reflector on the planting surface below the reflector.

According to an embodiment of the present disclosure, the above mentioned method is a computer implemented method i.e. performed by means of a computer.

According to an embodiment of the present disclosure, a light simulating computer program such as “TracePro” is used to perform the determination step. Preferably, the determination step is performed by applying an optimization process wherein the shape of the reflector and the diffusive reflectance values are changed and wherein the degree of spectral uniformity and irradiance uniformity of the light on the planting surface is calculated for the given boundary conditions. Preferably, the shape of the central portion of the reflector is set as a piecewise linear approximation of a parabola wherein the end point at the axis of symmetry is fixed and wherein the shape is optimized by changing the positions of the remaining connection points between the piecewise linear portions.

### BRIEF DESCRIPTION OF THE DRAWINGS

FIG. 1 shows a plant growing system comprising a plant illumination unit having multiple parallel plant illumination devices as is known in the prior art. FIG. 1a shows a cross-sectional view of the plant growing system, wherein the section has been taken along the length direction. FIG. 1b shows a cross-sectional view of the plant growing system wherein the section has been taken along the width direction, and along the section AA shown in FIG. 1a. FIG. 1c shows a top view of the plant illumination unit of the plant growing system.

FIG. 2 shows a plant growing system comprising a plant illumination unit having multiple parallel plant illumination devices according to an embodiment of the present disclosure. FIG. 2a shows a cross-sectional view of the plant growing system, wherein the section has been taken along the length direction. FIG. 2b shows a cross-sectional view of the plant growing system wherein the section has been taken along the width direction, and along the section BB shown in FIG. 2a. FIG. 2c shows a bottom view of the illuminating unit of the plant growing system with an indication in dotted lines where the light source is positioned.

FIG. 3 shows a variant of the plant growing system of FIG. 2 where the light source of each plant illumination device comprises multiple parallel light strips on each side of the axis of symmetry wherein each light strip is arranged to emit light of a different frequency range.

FIG. 4a shows a portion of the plant growing system of FIG. 3 with some paths of light rays leaving from the two light strips emitting light of a different frequency range as is indicated by the dotted line and the dash-dotted line, wherein the plant illumination device is of a sub-optimal type.

FIG. 4b shows a plot of the light irradiance as a function of distance from the reflector protrusion in the width direction when the plant illumination device of FIG. 4a is used.

FIG. 5a shows a portion of the plant growing system of FIG. 3 with some paths of light rays leaving from the two light strips emitting light of a different frequency range as is indicated by the dotted line and the dash-dotted line, wherein the plant illumination device is of an improved type.

FIG. 5b shows a plot of the light irradiance as a function of distance from the reflector protrusion in the width direction when the plant illumination device of FIG. 5a is used.

FIGS. 6a, 6b and 6c respectively illustrate a situation of perfectly specular reflection, perfectly diffuse reflection and partly diffuse reflection.

FIG. 7 shows several cos^n functions for n being 0, 1, 10 and 30.

FIG. 8 shows a variant of the plant growing system of FIG. 3 wherein the central portion of the reflector on each side of the symmetry axis is a piecewise linear approximation of a parabola.

### DETAILED DESCRIPTION

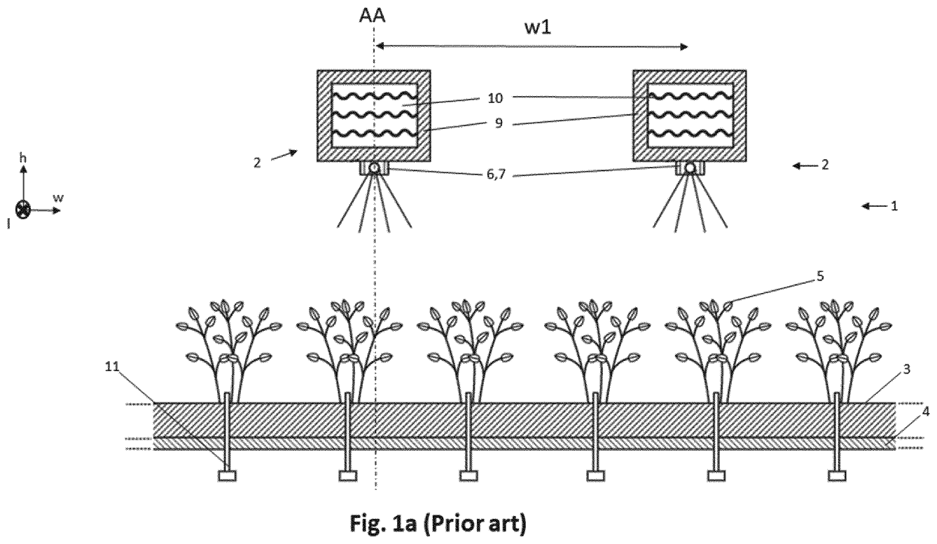

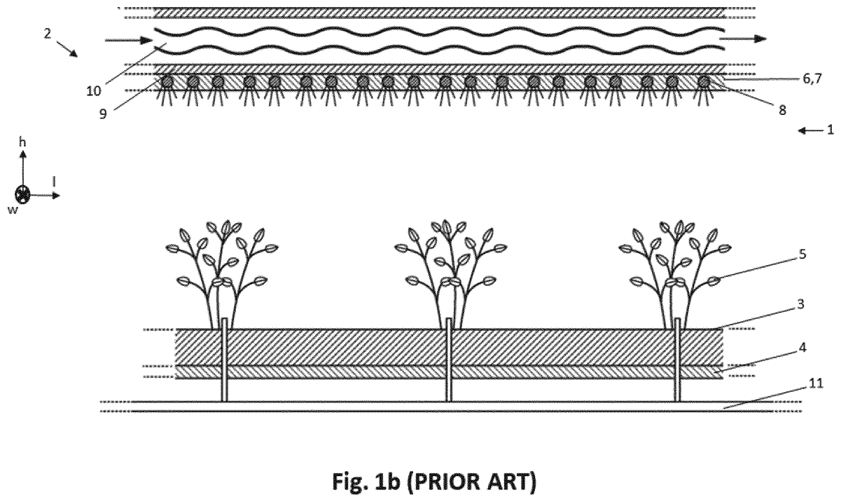

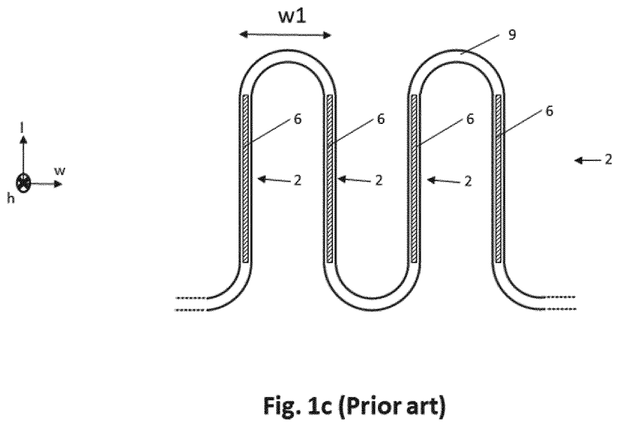

Plant illumination devices 2 have been developed in the prior art for illuminating plant trays 4 in a plant growing system 1. One such prior art plant illumination device 2 is shown in FIG. 1. The plant tray 4 comprises a planting surface 3 for receiving plants 5. For example, a plant illumination device for illuminating a plant tray is known from patent publication EP3772897. The planting surface 3 is a surface comprising a mutually perpendicular length (l) and width (w) direction, i.e. the planting surface is perpendicular to a height (h) direction. The plants 5 are watered by means of a watering duct 11 as described in patent publication EP3772897. In particular, a plant illumination unit is shown which is a grouping of multiple parallel plant illumination devices 2, wherein each plant illumination device has a light source 6 elongated in the length direction (l). The plant illumination unit shown in FIG. 1 comprises four plant illumination devices 2 (as shown in FIG. 1c, but only two plant illumination devices are drawn in FIGS. 1a and 1b). As is indicated in FIGS. 1a and 1c, the distance along the width direction by which light sources of adjacent plant illumination devices 2 are separated is W1. Each light source 6 comprises a single light strip 7 comprising multiple lighting elements 8. In particular, the light strip 7 is a LED strip comprising multiple LEDs 8. The light source is cooled by means of a heat conductive duct 9 carrying a cooling fluid 10 in the direction indicated by the arrows as described in patent publication EP3772897. As is shown by the light rays emanating from the lighting elements 8 in FIG. 1, the light source 6 only directly illuminates the plants 5 in the plant tray 4. This had the disadvantage that the irradiance of the light reaching plants in the plant tray depends on the position of the plants 5 in the plant tray 4, i.e. the plants directly below the light source would receive light with a higher irradiance than the plants that are at a different position in the width direction (w). It has however been found that the irradiance of the light affects plant growth, and thus the traditional plant illumination devices shown in FIG. 1 have the problem that plants in the plant tray are not lit with a uniform irradiance which results in non-uniform plant growth.

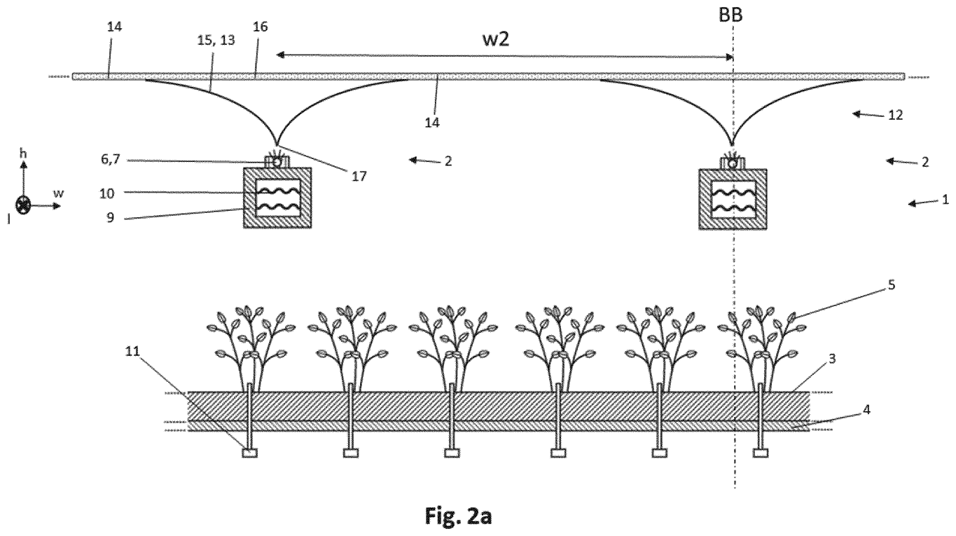

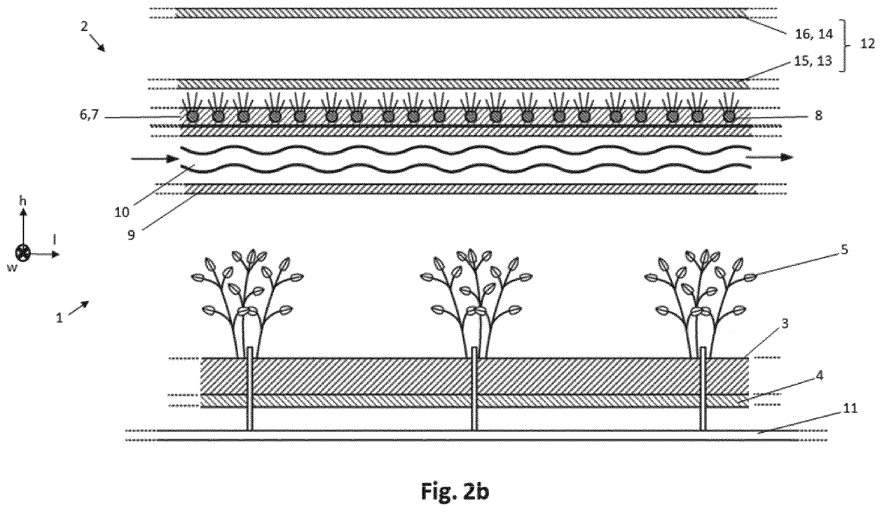

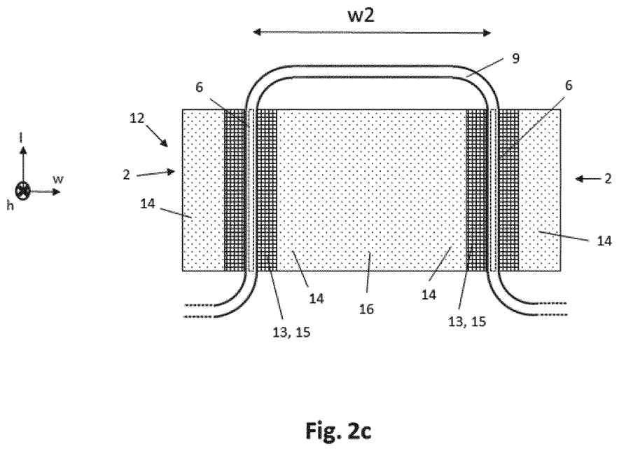

To solve the above mentioned problem, the plant illumination device 2 and the plant growing system 1 of the present disclosure are provided. An embodiment of such an illumination device 2 and plant growing system 1 is shown in FIG. 2. The plant illumination device 2 comprises a reflector 12 in addition to the light source 6. The light source 6 comprises the single light strip 7 having the multiple lighting elements 8 as described above. In particular, a plant illumination unit is shown which is a grouping of multiple parallel plant illumination devices 2, wherein each plant illumination device 2 has the aforementioned elongated light source 6 and the associated reflector 12. The plant illumination unit shown in FIG. 2 in particular comprises two parallel plant illumination devices 2. In each plant illumination device 2, the reflector 12 is positioned above the light source 6. The light source 6 is arranged to emit light solely directed towards the reflector 12, i.e. not directly towards the plant tray 4 as was the case in the prior art as explained above. The light source 6 and the reflector 12 are positioned such that the light emitted by the light source is reflected by the reflector 12 towards the plant tray 4. In other words, in use, the light source 6 is positioned between the reflector 12 and the plant tray 4. The reflector 12 and the light source 6 are both elongated along the length direction (l). As is best seen in FIG. 2a, the reflector 12 has a shape in a cross-sectional plane perpendicular to the length direction wherein said shape comprises a central portion 13 and two peripheral portions 14 adjacent to the central portion 13. The shown reflector 12 comprises two separate parts, a central part 15 on which the central portion 13 is provided and a ceiling part 16 on which the two peripheral portions 14 are provided. The ceiling part 16 of one plant illumination device 2 is shared with the adjacent plant illumination device 2. This can be seen in FIG. 2a where the same ceiling part 16 extends above the left and the right light sources 6. For each of the plant illumination devices 2, the above mentioned shape of the reflector is symmetrical with respect to an axis of symmetry extending through the central portion 13 along the height direction (h). Given that the reflector 12 is elongated in the length direction (l), the reflector 12 is symmetric along a plane of symmetry comprising the axis of symmetry and extending along the height (h) and length (l) direction. The central portion 13 comprises a protrusion 17 at the axis of symmetry wherein the protrusion protrudes downward along the height direction (h) towards the light source 6. The central portion 13 of the reflector 12 is arranged to receive light from the light source 6 and to reflect the received light towards the peripheral portions 14 of the reflector 12. The peripheral portions 14 of the reflector 12 are arranged to reflect the light received from the central portion 13 towards the plant tray 4. This reflector 12 has the advantage that a more uniform light irradiance is obtained over the planting surface (i.e. it increases the irradiance uniformity). It has the additional advantage that less light sources have to be provided per unit length along the width direction. Indeed, as can be seen in FIGS. 2a and 2c, the distance of separation along the width direction (w) between the light sources 6 of adjacent plant illumination devices 2 is W2. The distance W2 shown in FIGS. 2a, 2c is larger than the distance W1 shown in FIGS. 1a, 1c.

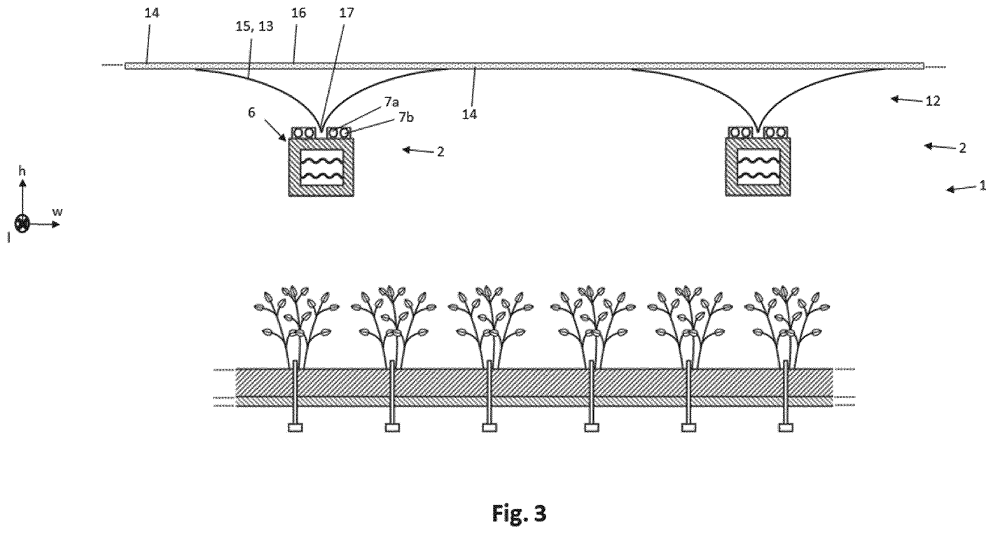

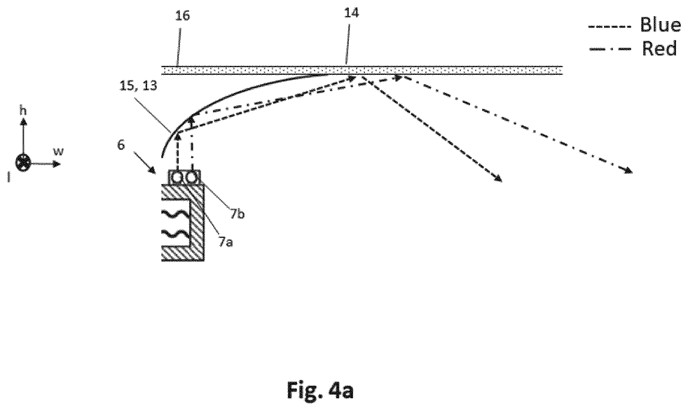

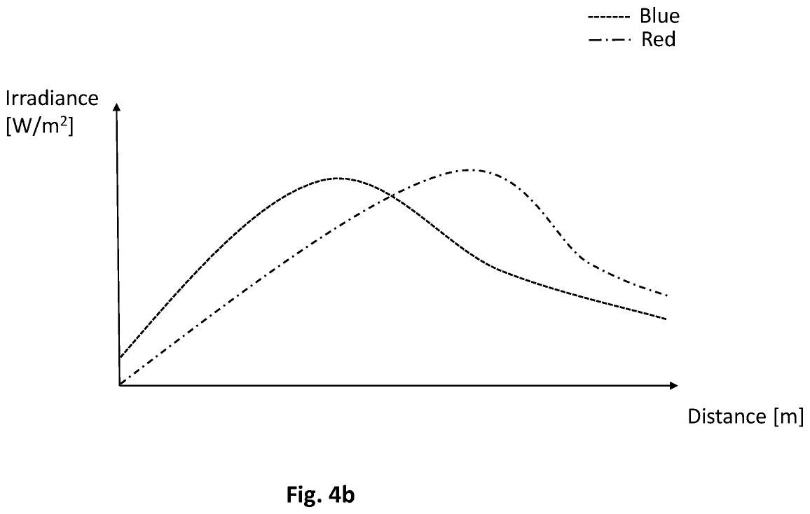

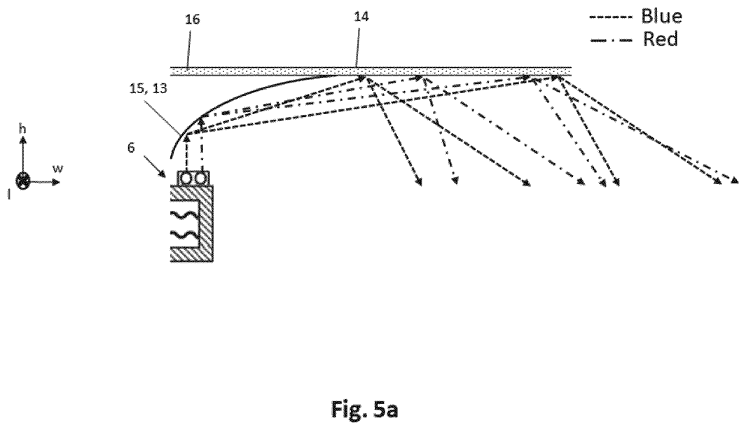

According to a preferred embodiment of the present disclosure, as is shown in FIG. 3, the light source 6 comprises on each side of the axis of symmetry through the protrusion 17, two parallel light strips 7a, 7b separated from each other along the width direction (w). Light strip 7a carries LEDs arranged to emit blue light, whereas strip 7b carries LEDs arranged to emit red light. This results in the fact that the light coming from the different light strips are differently reflected by the reflector 12 towards the plant tray 4, i.e. as a function of the light strip's position along the width direction the light rays of said light strip would be reflected by the central portion of the reflector towards a different position on the peripheral portion of the reflector and thus to a different position along the width direction on the plant tray 4. This is illustrated in FIG. 4a where the light rays emitted by light strip 7a are shown in a dashed line whereas light rays emitted by light strip 7b are shown in a dash-dotted line. It is noted that only one light ray is shown to leave each light strip. This is of course only for illustrative purposes. In practice, multiple light rays leave each light strip and direction in which the light ray is emitted is not per se along the height direction (h), i.e. the light strip emits light rays in multiple directions centered around the height direction (h). This results in a decreased irradiance uniformity and decreased spectral uniformity of the light at the planting surface 3 as is illustratively shown in FIG. 4b where the irradiance of the blue light emitted by light strip 7a is shown in a dashed line whereas irradiance of the red light emitted by light strip 7b are shown in a dash-dotted line. In order to resolve this problem the reflector 12 is adapted as shown in FIG. 5a where the light rays emitted by light strip 7a are shown in a dashed line whereas light rays emitted by light strip 7b are shown in a dash-dotted line. In particular, both the central 13 and the peripheral portions 14 of the reflector 12 are arranged to diffusively reflect the light from the light source 6 and the diffuse reflectance of the peripheral portions 14 is chosen to be higher than the diffuse reflectance of the central portion 16. For example, the central portion is made out of aluminum which is treated to have a diffusive reflectance of cos^30. For example, the peripheral portions 14 are coated with MCPET or I-reflect such as to have a diffusive reflectance below cos^10. The higher irradiance uniformity and spectral uniformity is illustratively shown in FIG. 5b, where the irradiance of the blue light emitted by light strip 7a is shown in a dashed line whereas irradiance of the red light emitted by light strip 7b are shown in a dash-dotted line.

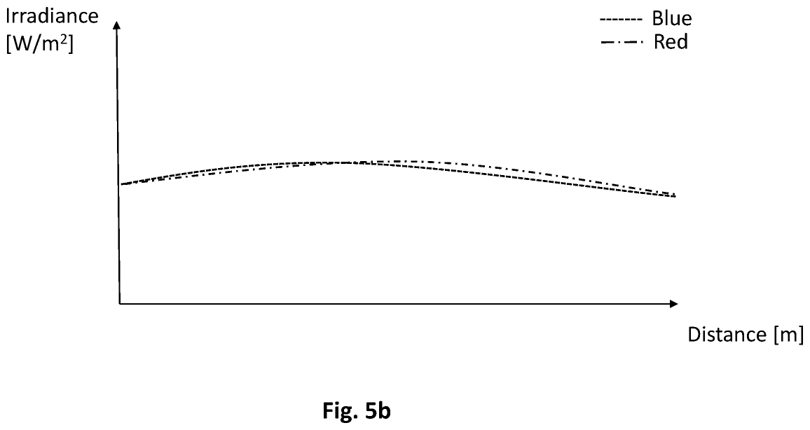

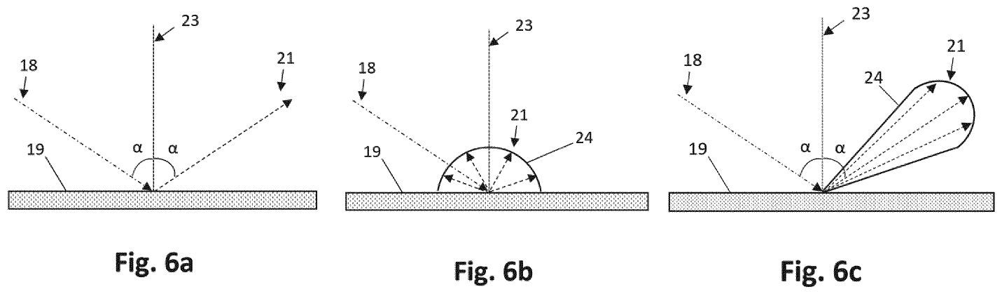

FIGS. 6a, 6b and 6c respectively illustrate a situation of perfectly specular reflection, perfectly diffuse reflection and partly diffuse reflection. In all three situations an incoming light ray is shown as indicated by reference number 18. The incoming ray reaches a surface 19 of a material under an incidence angle a with respect to the normal 23 to the surface. The incoming ray is differently reflected in the FIGS. 6a, 6b, 6c as is shown by the reflection rays 21. In case of the perfectly specular reflection shown in FIG. 6a, the reflected ray is reflected under a reflection angle which is equal to a. In case of partially or perfect diffuse reflection, the reflection rays 21 are distributed over multiple reflection angles, as shown by the envelope 24 bundling the multiple possible reflection rays 21.

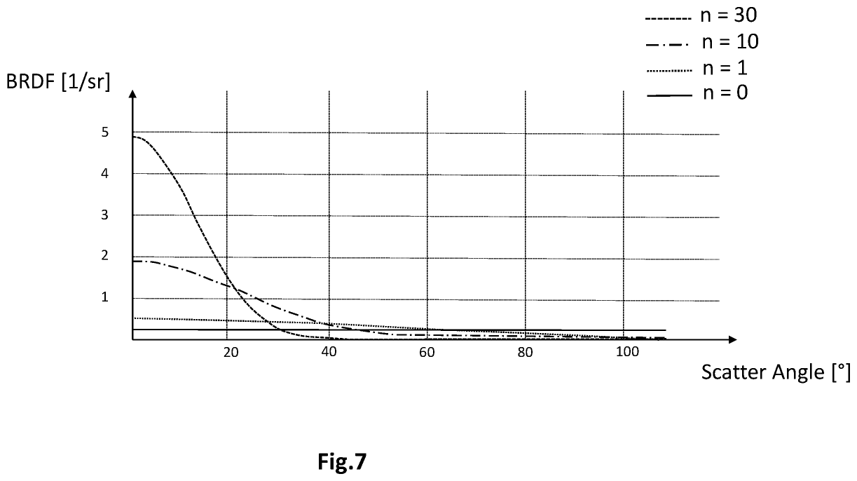

FIG. 7 shows several cos^n functions for n being 0, 1, 10 and 30. The horizontal axis represents the scattering angle, i.e. the deviation from the specular reflection direction. The vertical axis represents the amount of light scattered per steradian. The illustrated curves have been normalized such that the integral of the BRDF model in spherical polar coordinates are equal.

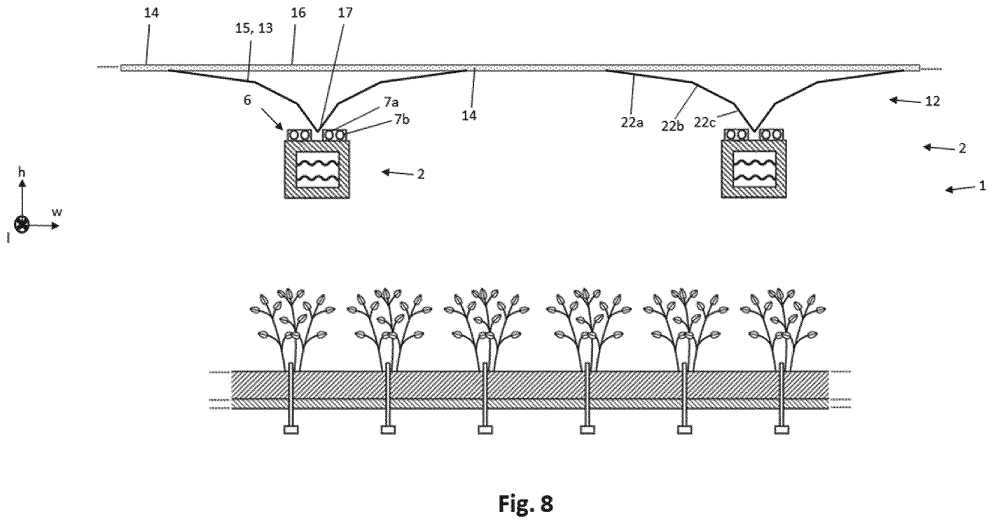

FIG. 8 shows a variant of the plant growing system of FIG. 3 where the central portion of the reflector 12 on each side of the symmetry axis is a piecewise linear approximation of a parabola. Each piecewise linear approximation of the parabola in particular comprises three linear sections 22a, 22b, 22c.

1. A plant illumination device arranged to be positioned above a plant tray such as to illuminate plants in the plant tray, the device comprising a reflector and a light source, wherein the light source is arranged to emit light directed towards the reflector, and wherein the light source and the reflector are positioned such that the light emitted by the light source is reflected by the reflector towards the plant tray, wherein the reflector and the light source are both elongated along a length direction, wherein the reflector has a shape in a cross-sectional plane perpendicular to the length direction wherein the shape comprises a central portion and two peripheral portions adjacent to the central portion and wherein the shape is symmetrical with respect to an axis of symmetry extending through the central portion along a height direction (h) perpendicular to the length direction, wherein the central portion comprises a protrusion at the axis of symmetry wherein the protrusion protrudes downward along the height direction towards the light source, wherein the central portion of the reflector is arranged to receive light from the light source and to reflect the received light towards the peripheral portions of the reflector, and wherein the peripheral portions of the reflector are arranged to reflect the light received from the central portion towards the plant tray.

2. The plant illumination device according to claim 1. wherein the protrusion divides the reflector into two adjacent concave elements.

3. The plant illumination device according to claim 2, wherein the central portion on one side of the axis of symmetry comprises an approximatively parabolic line which terminates on the axis of symmetry such as to form the protrusion of the central portion of the reflector.

4. The plant illumination device according to claim 3, wherein the approximatively parabolic line is a piecewise linear approximation of a parabola, wherein the piecewise linear approximation comprises at least three linear sections.

5. The plant illumination device according to claim 1, wherein the reflector comprises a width direction (w) perpendicular to the height direction and the length direction, and wherein the central portion of the reflector is the portion of the reflector that is shaped such that with increasing distance from an apex of the protrusion along the width direction, the height along the height direction increases.

6. The plant illumination device according to claim 5, wherein the peripheral portions of the reflector are the portions of the reflector that are substantially flat or wherein the peripheral portions of the reflector are the portions of the reflector that are shaped such that with increasing distance from the apex of the protrusion along the width direction, the height along the height direction decreases.

7. The plant illumination device according to claim 1, wherein the light source is arranged to emit PAR light.

8. The plant illumination device according to claim 1, wherein the light source comprises on each side of the axis of symmetry a plurality of parallel elongated light strips placed adjacent to each other along a width direction (w) perpendicular to the height direction and the length direction, and wherein at least two of the plurality of elongated light strips on each side of the axis of symmetry are arranged to emit light at a different range of wavelengths.

9. The plant illumination device according to claim 8, wherein at least one of the plurality of elongated light strips on each side of the axis of symmetry is arranged to emit predominantly blue light, and wherein at least one of the plurality of elongated light strips on each side of the axis of symmetry is arranged to emit predominantly red light.

10. The plant illumination device according to claim 6, wherein the elongated light strips are strips of LEDs.

11. The plant illumination device according to claim 1, wherein both the central and the peripheral portions of the reflector diffusively reflect the light from the light source and that the diffuse reflectance of the peripheral portions is higher than the diffuse reflectance of the central portion.

12. The plant illumination device according to claim 11, wherein the diffusive reflectance of the central portion is between cos^10 and cos^200.

13. The plant illumination device according to claim 11, wherein the diffusive reflectance of the peripheral portions is below cos^10.

14. A plant growing system comprising a plant tray extending in the length and width directions and the plant illumination device according to claim 1, wherein the plant illumination device is positioned in the height direction above the plant tray such that the light source is positioned between the reflector and the plant tray.

15. The plant growing system according to claim 14, wherein the plant tray is covered in a perfectly diffuse reflective material.

16. The plant growing system according to claim 14, wherein the plant tray is a hydroponics based plant tray.

17. A method for providing a plant growing system according to claim 14, wherein the method comprises the steps of:
obtaining boundary conditions comprising a) a distance between the light source and the planting surface of the plant tray, b) dimensions of the planting surface of the plant tray, and c) a distance between the light source and the protrusion of the reflector, and
determining the shape of the reflector, and a diffusive reflectance of the central portion and the peripheral portions such as to optimize a spectral uniformity and an irradiance uniformity of the light which is reflected by the reflector on the planting surface below the reflector.

18. A computer implemented method comprising the method steps according to claim 17, performed by means of a computer.
